(19) United States
(12) Patent Application Publication
(10) Pub. No.: US 2011/0229595 A1
(43) Pub. Date: Sep. 22, 2011

(54) CASTING, MOLDING OR PRESSING TOOL WITH TEMPERATURE CONTROL MEDIUM CHANNELS

(75) Inventors: Werner Krömmer, Landshut (DE); Rolf Heninger, Hohenkirchenf (DE); Andreas Kürten, Iserlohn (DE); Guido Peters, Gummersbach (DE); Andreas Praller, Germering (DE)

(73) Assignee: LINDE AKTIENGESELLSCHAFT, Munich (DE)

(21) Appl. No.: 13/049,232

(22) Filed: Mar. 16, 2011

(30) Foreign Application Priority Data
Mar. 18, 2010 (DE) 10 2010 003 033.3

(51) Int. Cl. B29C 33/02; B29C 35/00; C23C 4/00; B29C 39/38

(52) U.S. Cl. 425/406; 425/470; 427/446; 249/79

(57) ABSTRACT

In a method of producing a casting, molding or pressing tool (1) or tool insert (2) with at least one material layer (3, 5, 7) and with temperature control medium channels (6) arranged in the at least one material layer (3, 5, 7), the temperature control medium channels (6) are introduced into the at least one material layer (3, 5, 7) using a thermal spray process (2).

### CROSS REFERENCE TO RELATED APPLICATIONS

This application claims priority of the German patent application 10 2010 003 033.3 filed Mar. 18, 2010 which is incorporated by reference herein.

### FIELD OF THE INVENTION

The present invention relates to a method of producing a casting, molding or pressing tool or a corresponding tool insert having at least one material layer and having temperature control medium channels arranged in the at least one material layer, a correspondingly produced casting, molding or pressing tool or a correspondingly produced tool insert, a material layer of a tool or tool insert of this kind, and a casting, molding or pressing process using a tool or tool insert of this kind.

Although the present invention is described hereinafter predominantly with respect to the injection molding of plastics parts, it is not restricted to this but can be used in a variety of pressing, casting or molding processes, for example in the light metal die casting of aluminium, magnesium or zinc or, as an alternative to injection molding, in the pressing of plastics parts.

### BACKGROUND OF THE INVENTION

Particularly in the injection molding of plastics parts it may be necessary to heat particular areas of the tool locally, for example in order to achieve better flow characteristics of the melt or a higher accuracy of reproduction as a result of a lower viscosity of the casting material. For this purpose it is known to provide heatable tool inserts or heatable areas in an injection molding tool.

Heating elements which may be used for this may be produced for example with a sandwich construction in which individual layers of the heating element are introduced one after another into an injection molding tool or tool insert and screwed into position. As a rule, first of all, starting from the tool side and progressing towards the casting cavity, a first electrical insulating layer, a heating layer, a second electrical insulating layer and finally a, typically, metallic finishing layer (hereinafter referred to as the “metal layer”) are introduced. The insulating layers are typically made of ceramic material while the heating layer may be, for example, a ceramic or metallic electrical resistor or an inductively heatable element. The materials for the metal layer are generally selected for their ease of machining

The coatings may be produced using known thermal spraying methods such as flame, plasma and cold gas spraying. The corresponding production of heating layers in heating devices for components of injection molding tools is disclosed in DE 2005 018 062 B4. In this, first an insulating base layer is produced on a body made of a thermally conductive material, and to this is applied a coating of electrically conductive material as a resistor in the form of at least one strip.

The local heating of an injection molding tool by a heatable insert naturally leads to the plastics melt being more powerfully heated in this region than in the surroundings. Before a workpiece produced by injection molding can be demolded, however, it must have fallen below the demolding temperature at every point, as otherwise undesirable deformation could occur as a result of and subsequent to the demolding. Regions which have been additionally heated locally and therefore reach the demolding temperature at a later time are thus the determining factor for the cycle time of a corresponding injection molding process and, in the last analysis, for the economic viability of the process.

Injection molding tools usually have temperature control medium channels for cooling with water or oil for the purpose of cooling the castings or moldings produced. However, as there is a greater distance between these temperature control medium channels and the surface of the tool precisely in the areas with an additional heating device, the thermal conduction and hence the cooling rate are reduced. However it is precisely in these regions that there is an increased cooling requirement. The general requirement when producing injection molding tools, according to which specific distances have to be maintained between the temperature control medium channels relative to one another and to the surface of the cavity, cannot therefore always be met in injection molding tools with heatable tool inserts.

For the efficient cooling of injection molding tools, particularly in sensitive areas (so-called hot spots in which local temperature peaks may occur) DE 199 18 428 C1 discloses a method of cooling with carbon dioxide in which pressurised carbon dioxide is conveyed into tool areas provided for this purpose via a conduction system in the form of temperature control medium channels, in order to cool these regions by controlled expansion of the carbon dioxide. This process leads to a highly effective cooling performance, but the distance between the temperature control medium channels and the tool cavity is not reduced by the use of carbon dioxide cooling.

A general problem with heated and subsequently cooled components is the considerable mechanical and thermal stresses which are produced for example by different thermal expansion co-efficients. Where there are very great temperature differences, such as may occur for example when using carbon dioxide cooling, these problems are significantly intensified. In particular, disadvantages of this kind occur in heating elements of a sandwich structure. To overcome these disadvantages, corresponding materials must be carefully selected and high manufacturing accuracy must be maintained. Both requirements significantly increase the production costs of corresponding heating systems.

There is therefore a need for casting, molding or pressing tools or tool inserts with temperature control medium channels introduced into layers of material that can be produced using inexpensive methods and/or materials by the simplest possible means.

### SUMMARY OF THE INVENTION

Against this background the present invention provides a method of producing a casting, molding or pressing tool or tool insert having at least one layer of material and having temperature control medium channels disposed in the at least one layer of material, a casting, molding or pressing tool produced by the method or a corresponding tool insert, a material layer of such a tool or tool insert and a casting, molding or pressing method using corresponding tools or tool inserts having the features of the independent claims. Preferred embodiments are the subject of the subclaims and the description that follows.

According to the invention the temperature control medium channels are introduced into at least one material layer using a thermal spraying process. Particularly in view of the requirements mentioned above a thermal spraying process of this kind has proved particularly advantageous. Thus the production of the individual layers by thermal spraying is recommended particularly by the fact that no disadvantageous manufacturing tolerances are involved and a full-surface and leak tight bond can be produced. This applies particularly when an additional adhesive layer (“bond coat”) is introduced between the individual layers and at the interface between the substrate and the layer, thus achieving effective adhesion. As a result, a corresponding layer may be completely thermally sprayed, i.e. no different operations are required anymore.

Thermal spray methods such as flame, plasma and cold gas spraying are known per se for the production of coatings. In flame spraying a coating material in the form of a powder, cord, rod or wire is heated in a gas flame and sprayed at high speed onto a base material by means of additionally supplied fluids, e.g. compressed air. In plasma spraying, powder is injected into a plasma jet and is melted by the high plasma temperature. The plasma stream carries the powder particles along and hurls them onto the workpiece that is to be coated. In cold gas spraying, as described for example in EP 04 84 533 B1, the spray particles are accelerated to a high speed in a process gas. The temperature of the process gas is selected such that the sprayed particles may be heated but are not melted. The coating is formed as the particles strike the coating substrate with high kinetic energy, wherein the particles, which do not melt in the process gas, form a particularly dense, homogeneous firmly adhering layer as they make contact.

The thermal spraying methods described result in significantly improved properties of coatings and materials. The products thus produced have a high wear resistance and corrosion resistance. By a choice of suitable components it is possible to achieve a particularly good thermal and/or electrical conductivity and/or particularly advantageous expansion characteristics of corresponding components.

The invention therefore provides a particularly flexible and inexpensive method by which temperature control medium channels can be produced in layers of material of casting, molding or pressing tools or tool inserts with particularly advantageous properties.

The method according to the invention allows for a simple, fast and flexible production of tools and tool inserts, which can be used more efficiently and have a longer service life. Particularly in systems with carbon dioxide cooling, the introduction of temperature control medium channels according to the invention brings about a further improvement in the cooling properties.

The method according to the invention can be used in particular to produce free form heaters with correspondingly arranged temperature control medium channels. By contrast, up until now ceramic heaters, in particular, have generally only been able to be produced in the form of flat (two dimensional) bodies with which convex surfaces, for example, had to be approximated. The lining of concave casting cavities with heating elements thus conventionally takes place in the form of flat “tiles”, whereas with a spraying process the concave shape can be directly replicated.

The temperature control medium channels may be introduced into both heated and unheated pressing tools. The provision of the temperature control medium channels produced according to the invention may be in addition to other, particularly conventional cooling systems.

The temperature control medium channels produced according to the invention may be used particularly advantageously for cooling a tool, i.e. as coolant channels, as already explained. However, temperature control medium channels of this kind may also be used to heat the tool by passing a hot medium, e.g. gaseous carbon dioxide, through the channels instead of the coolant. In the latter case a tool can be effectively heated even without the use of electrical heating means, but temperature control medium channels may also be used to assist any electrical heating provided. Moreover, it is particularly advantageous to use corresponding temperature control medium channels first to heat a tool using a hot medium and then cool it using a cold medium. For this, separate heating and cooling channels may be used, or channels with a dual function. In the latter case the construction costs in the manufacture and operation of a corresponding tool can be significantly reduced. It is also possible to give temperature control medium channels or their walls specific resistance properties so that an electro-resistive heating can be brought about by applying a voltage.

The method may advantageously be used in systems of very different configurations. Thus, at least one insulating layer, followed by at least one heating layer and then another insulating layer may be introduced into a tool insert for locally heating corresponding areas. The final insulating layer is then covered with a metal layer facing the casting cavity. The metal layer may subsequently be polished or otherwise finished.

On the other hand, the layer structure may also be done differently in individual parts of a tool insert. Thus a heating layer may also be provided, for example, only in certain areas that are to be heated. One or more of the above-mentioned layers may be applied by thermal spraying methods, with particular advantage. In particular, the electrical connections of a heating layer may also be provided in the course of the layer construction by spraying methods. For example, a heating element may also be placed in a corresponding tool insert whereas the connections are produced by a spraying process.

The temperature control medium channels may be provided in an insulating layer, a metal layer, a heating layer or several such layers. If the temperature control medium channels are located in a metal layer or if they consist of metal, electrical insulation may be advantageous. Naturally, a heating layer of a layer structure is heated most. If this heating layer can be effectively cooled, for example by temperature control medium channels provided in an adjacent insulating layer, particularly efficient cooling is achieved. If, however, the temperature control medium channels are arranged closer to the casting cavity, i.e. in a corresponding metal layer, for example, a particularly effective and dynamic cooling can be achieved which ensures that the casting is only exposed to the elevated temperature for the minimum time. Thus the shape of the tool is no longer exclusively responsible for the effectiveness of cooling.

Advantageously, the temperature control medium channels may be introduced into the respective material layer at least partly using a lost mold. For this, solid material is applied to an underlying layer and fixed, to some extent as a spacer for the channels and optionally for corresponding distribution and collecting systems. Fixing may be done for example by adhesive bonding but a corresponding lost mold may itself be applied by a suitable spraying process, for example by cold gas spraying using a die. The outer contours of the mold material correspond precisely to the dimensions of the cooling channels that are to be formed.

It is advantageous if the contour does not have any undercuts which may not be fully reached during spraying. Ideally a semi-circular profile would be suitable in this context, for example. After the mold has been applied spraying takes place around it by the thermal spray method. After this step or after the production of a corresponding tool insert, the mold material has to be released from the tool insert. This may be done for example using physical-thermal methods (melting out by heating) or chemical methods (releasing by the use of acids, alkalis or solvents). Suitable materials for corresponding molds therefore have to have properties capable of withstanding the stresses of thermal spraying (mechanical and thermal stress), on the one hand, but must also be easily released, on the other hand.

If a melting process is used for a lost mold, zinc or tin or certain plastics and synthetic resins may be used as the mold materials, for example, while for chemical processes acid-soluble materials such as certain metals may be used.

By the use of a lost mold it is possible to produce temperature control medium channels with channel walls that correspond to the surrounding material. Possible negative effects of different co-efficients of expansion are thus avoided entirely.

In certain cases it may also prove advantageous to introduce temperature control medium channels at least partly by spraying around (prefabricated) channel elements. For this purpose, temperature control medium channels which are optionally already fixedly attached to a distribution and collecting system may be placed on an underlying layer, i.e. a substrate, and fixed thereon. Material is then sprayed around the correspondingly fixed channels. Temperature control medium channels of this kind subsequently remain unchanged in the tool insert. As a result the wall properties of corresponding temperature control medium channels can be chosen to be different from the surrounding material, in a particularly advantageous manner. For example, particularly good compressive strength or thermal stress resistance of the walls of temperature control medium channels can thus be achieved.

In both cases it is possible to provide correspondingly produced temperature control medium channels with surface coatings by means of subsequent lining processes.

A temperature control medium distribution and/or collecting system may also be provided, to particular advantage, in conjunction with the temperature control medium channels using the spray process. This is a very simple way of producing a tool insert or a corresponding pressing or casting tool which ideally then has only to be connected to an inlet and outlet of a temperature control medium system or circuit.

With regard to the casting, molding or pressing tools or tool inserts which are also provided according to the invention, the material layers of corresponding tools or tool inserts and the casting or pressing process according to the invention, reference is specifically made to advantages and features described hereinbefore.

By the use of such apparatus and processes it is possible to achieve a significant increase in the productivity of injection molding and die stamping processes as it enables rapid and uniform cooling (and optionally also heating) of the injected material in the mold. The length of time until an injection molded or die-stamped component can be demolded is hereby significantly reduced, with the result that the cycle time of a corresponding apparatus can be reduced.

### BRIEF DESCRIPTION OF THE DRAWING VIEWS

The invention and its advantages and further embodiments of the invention are hereinafter explained in more detail with reference to the embodiments shown by way of example in the drawings, wherein specifically:

FIG. 1 shows a casting, molding or pressing tool with a tool insert according to a particularly preferred embodiment of the invention and

FIG. 2 shows a casting, molding or pressing tool with a tool insert according to another preferred embodiment of the invention.

### DETAILED DESCRIPTION OF THE INVENTION

In the drawings, identical or similar elements are shown with identical reference numerals. The associated description is not repeated, in the interests of clarity.

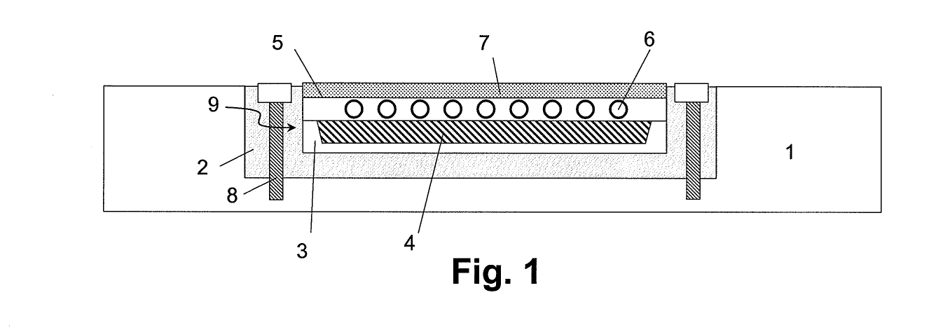

FIG. 1 schematically shows a part of a casting, molding or pressing tool 1 of a pressing or injection apparatus. The tool 1 comprises a tool insert 2 which is attached to the tool 1 by screws 8. The tool insert 2 has a layered structure 9 which will be explained hereinafter.

The layer structure 9 has an insulating material 3 on the substrate side. The insulating material 3 which is pulled upwards at its side edges to ensure lateral insulation is advantageously applied by a spraying process or placed in a tool insert. Advantageously a ceramic material is used for the insulating layer 3. A heating layer 4, for example an electro resistive or inductive heater 4, is provided on the insulating layer 3, by spraying or by some other method. The heating layer 4 may comprise electrical connections (not shown) which may also be produced by a spray process. The heating layer 4 is covered with another insulating layer 5. Temperature control medium channels 6 are provided in this additional insulating layer 5. As already explained, the temperature control medium channels may be introduced using a lost mold or by spraying around prefabricated temperature control medium channel elements.

Advantageously, although this is not shown in the figure, a corresponding temperature control medium distribution or collecting system may be introduced in addition, together with the temperature control medium channels 6, i.e. also in the insulating layer 5. If appropriate, the temperature control medium distribution or collecting system may also be provided in other layers or in the tool itself.

To produce the temperature control medium channels 6, for example, a first layer of an insulating layer 5 may first be applied to the heating layer 4 or the laterally raised regions of the first insulating layer 3 to produce a wall of the temperature control medium channels 6 on the heating layer side. Then, as explained above, a mold is introduced or prefabricated temperature control medium channel elements are fixed to the first insulating layer which has previously been introduced. The temperature control medium channels inserted or the mold applied then have additional insulating layer material sprayed around them.

Finally, another material layer 7 is applied, for example a machineable metal layer 7 which is a good conductor of heat, is applied to the tool surface.

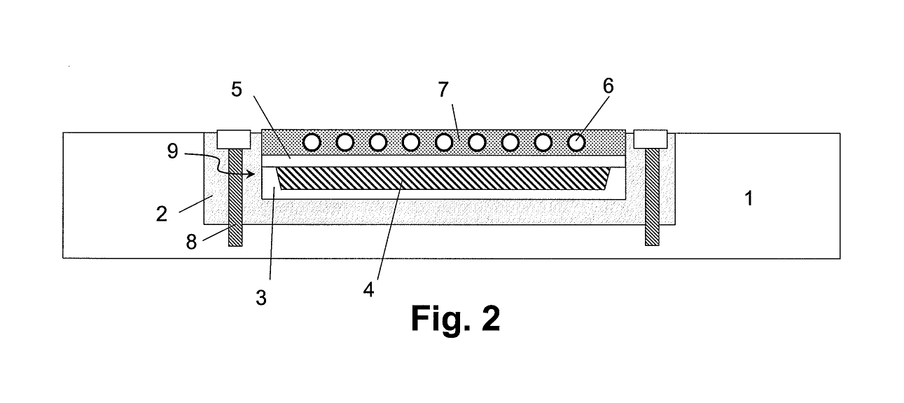

FIG. 2 also shows part of a corresponding casting, molding or pressing tool 1 which comprises a tool insert 2. Unlike in FIG. 1, however, the temperature control medium channels 6 in this case are formed in the final metal layer 7 on the surface of the tool.

It will be understood that even if FIGS. 1 and 2 show tools with tool inserts 2, the layer structure with temperature control elements according to the invention may also be applied directly to a tool surface, i.e. to a tool without a tool insert.

What is claimed is:

1. A method of producing a casting, molding or pressing tool or tool insert having at least one material layer and having temperature control medium channels arranged in the at least one material layer, wherein the method comprises the step of using a thermal spray process to introduce the temperature control medium channels into the at least one material layer.

2. The method according to claim 1, wherein the thermal spray process is selected from the group of thermal spry processes consisting of plasma spraying, flame spraying, and cold gas spraying.

3. The method according to claim 1, wherein the at least one material layer includes at least one insulating layer.

4. The method according to claim 1, wherein the at least one material layer includes at least one heating layer.

5. The method according to claim 1, wherein the at least one material layer includes at least one metal layer.

6. The method according to claim 1, wherein the at least one material layer includes at least one insulating layer, at least one heating layer, and at least one metal layer.

7. The method according to claim 1, wherein the temperature control medium channels are at least partly introduced using a lost mold.

8. The method according to claim 7, wherein the lost mold is prepared using a material that can be melted out and/or dissolved out.

9. The method according to claim 1, wherein the temperature control medium channels are at least partly introduced by spraying material around channel elements.

10. The method according to claim 9, wherein channel elements that have been prefabricated and/or that are placed on a substrate are used as the channel elements.

11. The method according to claim 1, further comprising the step of introducing a temperature control medium distribution and/or collecting system in conjunction with the temperature control medium channels.

12. A casting, molding or pressing tool or tool insert having at least one material layer and having temperature control medium channels arranged in the at least one material layer, wherein the temperature control medium channels are introduced into the at least one material layer using a thermal spray process.

13. The casting, molding or pressing tool or tool insert according to claim 12, wherein the temperature control medium channels are cooling and/or heating channels formed to convey carbon dioxide.

14. A material layer of a casting, molding or pressing tool or tool insert having temperature control medium channels arranged therein, wherein the temperature control medium channels are introduced into the material layer using a thermal spray process.

15. The material layer according to claim 14, wherein the temperature control medium channels are cooling and/or heating channels formed to convey carbon dioxide.
